(19) United States
(12) Patent Application Publication
(10) Pub. No.: US 2025/0050675 A1
(43) Pub. Date: Feb. 13, 2025

(54) IMAGE FORMING METHOD

(71) Applicant: BROTHER KOGYO KABUSHIKI KAISHA, Nagoya (JP)

(72) Inventors: Sota MACHII, Miyoshi (JP); Nozomi SUZUKI, Nisshin (JP)

(73) Assignee: BROTHER KOGYO KABUSHIKI KAISHA, Nagoya (JP)

(21) Appl. No.: 18/797,603

(22) Filed: Aug. 8, 2024

(30) Foreign Application Priority Data
Aug. 9, 2023 (JP) 2023-130503

(51) Int. Cl. B41M 5/52; B41J 2/315; B41M 5/00

(52) U.S. Cl. CPC B41M 5/5272; B41J 2/315; B41M 5/0011; B41J 2202/03

(57) ABSTRACT

An image forming method for forming an image on a non-permeable substrate, which is water proof, includes: forming a resin layer on the non-permeable substrate; adhering a transfer sheet having a sublimable dye ink layer on a surface thereof to the resin layer, the sublimable dye ink layer comprising a sublimable dye ink; and heating the transfer sheet to transfer the sublimable dye ink to the resin layer. Forming the resin layer includes: ejecting a dispersion liquid which includes resin particles from an inkjet head to be adhered to the non-permeable substrate, such that the resin particles are fixed on the non-permeable substrate to form the resin layer.

### REFERENCE TO RELATED APPLICATIONS

This application claims priority from Japanese Patent Application No. 2023-130503 filed on Aug. 9, 2023. The entire content of the priority application is incorporated herein by reference.

### BACKGROUND ART

The present disclosure relates to an image forming method for forming an image on a non-permeable substrate using thermal transfer.

In a known method of subjecting a blended fiber containing a polyester fiber to printing using a disperse dye ink, the blended fiber is pretreated with a printing pretreatment agent containing at least polyester resin particles and a styrene-butadiene resin emulsion, and the disperse dye ink is sublimated and transferred.

### SUMMARY

According to an aspect of the present disclosure, an image forming method for forming an image on a non-permeable substrate, which is water proof, includes: forming a resin layer on the non-permeable substrate; adhering a transfer sheet having a sublimable dye ink layer on a surface thereof to the resin layer, the sublimable dye ink layer comprising a sublimable dye ink; and heating the transfer sheet to transfer the sublimable dye ink to the resin layer. Forming the resin layer includes: ejecting a dispersion liquid which includes resin particles from an inkjet head to be adhered to the non-permeable substrate, such that the resin particles are fixed on the non-permeable substrate to form the resin layer.

### DESCRIPTION

As used herein, the words “a” and “an” and the like carry the meaning of “one or more.” When an amount, concentration, or other value or parameter is given as a range, and/or its description includes a list of upper and lower values, this is to be understood as specifically disclosing all integers and fractions within the given range, and all ranges formed from any pair of any upper and lower values, regardless of whether subranges are separately disclosed. Where a range of numerical values is recited herein, unless otherwise stated, the range is intended to include the endpoints thereof, as well as all integers and fractions within the range. As an example, a stated range of 1-10 fully describes and includes the independent subrange 3.4-7.2 as does the following list of values: 1, 4, 6, 10.

In recent years, it has become desirable to perform full-color printing on a three-dimensional object such as a cup. Although there are various materials for the three-dimensional object, it is particularly desirable that an image having good color development without bleeding or unevenness is printed on a water-proof non-permeable substrate, such as an inorganic material and a resin having a high glass transition point.
(1) An embodiment of the present disclosure is related to an image forming method for forming an image on a water-proof non-permeable substrate. The image forming method includes a resin layer forming step of allowing a dispersion liquid containing resin particles to adhere to the non-permeable substrate by ejecting the dispersion liquid from an inkjet head, and fixing the resin particles as a resin layer on the non-permeable substrate; and a transfer step of allowing a transfer sheet having a sublimable dye ink layer to adhere to the resin layer and transferring a sublimable dye ink in the sublimable dye ink layer to the resin layer by heating.

An image having good color development without bleeding or unevenness can be formed on a non-permeable substrate. In addition, the resin layer can be formed on a part of the non-permeable substrate. In addition, the transfer sheet has excellent peelability. In addition, the formed image has few irregularities. Further, the non-permeable substrate has excellent color concealment properties.
(2) The non-permeable substrate may contain an inorganic material or a resin material having a glass transition point of 90° C. or higher.

Accordingly, the transfer sheet has more excellent peelability.
(3) The resin layer may contain a volatile component of 20 wt % or less.

Accordingly, the image has less unevenness.
(4) In the resin layer forming step, an amount of the dispersion liquid to be ejected onto the non-permeable substrate may be in a range of 0.1 mg/cm² to 10 mg/cm².

Accordingly, the image has better color development and less unevenness. In addition, the transfer sheet has more excellent peelability.
(5) A heating temperature in the transfer step may be in a range of 100° C. to 240° C.
(6) The resin particles may include at least one of a urethane-based resin, a polyester-based resin, and an acrylic resin.
(7) The resin particles may include at least one of a polyester-based resin and an acrylic resin.

Accordingly, the image has better color development. In addition, the transfer sheet has more excellent peelability.
(8) The polyester-based resin or the acrylic resin may have a glass transition point of 40° C. or higher.

Accordingly, the transfer sheet has more excellent peelability.
(9) The dispersion liquid may further include a crosslinking agent.

Accordingly, the image has better color development. In addition, the transfer sheet has more excellent peelability.
(10) The dispersion liquid may include a first dispersion liquid containing a coloring material and a second dispersion liquid containing no coloring material, and the resin layer forming step may include a first step of allowing the first dispersion liquid to adhere to the non-permeable substrate by ejecting the first dispersion liquid from an inkjet head, and fixing the resin particles as a first resin layer on the non-permeable substrate by heating, and a second step of allowing the second dispersion liquid to adhere to the first resin layer by ejecting the second dispersion liquid from an inkjet head, and laminating the resin particles as a second resin layer on the first resin layer.

Accordingly, the image has better color development. Further, the non-permeable substrate has more excellent color concealment properties.

According to the embodiments of the present disclosure, an image having good color development without bleeding or unevenness can be formed on a non-permeable substrate using thermal transfer.

Hereinafter, a preferred embodiment of the present disclosure will be described. Note that, the present embodiment is merely one embodiment of the present disclosure, and it is needless to say that the embodiment can be modified without changing the gist of the present invention.

An image forming method for forming an image on a non-permeable substrate includes a resin layer forming step and a transfer step. According to the present image forming method, an image having good color development without bleeding or unevenness can be formed on the non-permeable substrate. In addition, a resin layer can be formed on a part of the non-permeable substrate. In addition, a transfer sheet has excellent peelability. In addition, the formed image has few irregularities. Further, the non-permeable substrate has excellent color concealment properties.

The non-permeable substrate is not limited as long as it does not allow a liquid to permeate, and examples thereof include a glass, a metal, and a resin. In addition, the non-permeable substrate may be made of two or more materials. The shape of the non-permeable substrate is not limited, and may be a sheet or a flat plate, or a three-dimensional object with various shapes. It is preferable that the surface of the non-permeable substrate on which the image is to be formed is an inorganic material or a resin material having a glass transition point of 90° C. or higher since the transfer sheet has excellent peelability. Examples of the inorganic material include a glass and a metal. Examples of the resin material having a glass transition point (Tg) of 90° C. or higher include polymethyl methacrylate (Tg=90° C.), a polystyrene (Tg=100° C.), polyacrylonitrile (Tg=104° C.), a polyacrylic acid (Tg=106° C.), a polycarbonate (Tg=150° C.), a polymethacrylic acid (Tg=185° C.), and a copolymer thereof. A substrate having a low glass transition point, such as a synthetic resin such as vinyl chloride, may be deformed when heated for transfer. In addition, it is thought that the transfer sheet and a resin layer containing a sublimable dye ink are incorporated into the substrate, resulting in poor color development and also poor peelability of the transfer sheet.

In the resin layer forming step, a dispersion liquid containing resin particles is allowed to adhere to a non-permeable substrate by being ejected from an inkjet head, and the resin particles are fixed as a resin layer to the substrate.

The resin particles form a film on the non-permeable substrate when the dispersion liquid is dried. Examples of the resin particles include an acrylic resin, a maleic acid-based ester resin, a vinyl acetate-based resin, a carbonate-based resin, a polycarbonate-based resin, a styrene-based resin, an ethylene-based resin, a polyethylene-based resin, a propylene-based resin, a polypropylene-based resin, a urethane-based resin, a polyurethane-based resin, a polyester-based resin, and a copolymer resin thereof. When the resin particles contain at least one of a polyester-based resin and an acrylic resin, the image has good color development and the transfer sheet has excellent peelability. When the glass transition point of the polyester-based resin or the acrylic resin is 40° C. or higher, the transfer sheet has more excellent peelability.

The dispersion liquid may also contain a solvent. Examples of the solvent include tripropylene glycol, propylene glycol, 1,5-pentanediol, 1,3-propylene glycol, 1,2-butanediol, 1,3-butanediol, 1,4-butanediol, and 3-methyl-1,5-pentanediol. The solvent is contained as a volatile component in the resin layer. The content of the volatile component in the resin layer is preferably 20 wt % or less, more preferably 10 wt % or less, and particularly preferably 5 wt % or less. When the content of the volatile component in the resin layer satisfies the above range, the image has little unevenness. Since the volatile component in the resin layer has a function of fluidizing the sublimable dye ink after transfer, when a large amount of the volatile component remains in the resin layer, blurring or unevenness tends to occur at color boundaries, which is thought to result in a poor image quality.

The dispersion liquid may further contain a crosslinking agent. Examples of the crosslinking agent include a blocked isocyanate compound, a carbodiimide compound, and an oxazoline compound. The content of the crosslinking agent is preferably 5 wt % or less. It is thought that, when the dispersion liquid contains a crosslinking agent, polymer chains of the resin are crosslinked by the crosslinking agent, making the glass transition point of the crosslinked resin layer is higher than the original glass transition point of the resin, so that the transfer sheet is difficult to adhere to the resin layer and has excellent peelability. It is also thought that the sublimable dye ink is more likely to be retained in the crosslinked structure of the resin layer, so that the image has better color development.

The dispersion liquid may contain a first dispersion liquid containing a coloring material and a second dispersion liquid containing no coloring material. The coloring material is, for example, a water-dispersible pigment. Examples of the coloring material include a white inorganic pigment and a white organic pigment. Examples of the inorganic pigment include titanium oxide and an iron oxide-based inorganic pigment. Examples of the organic pigment include: azo pigments such as azo lake, an insoluble azo pigment, a condensed azo pigment, and a chelate azo pigment; polycyclic pigments such as a phthalocyanine pigment, a perylene and perinone pigment, an anthraquinone pigment, a quinacridone pigment, a dioxazine pigment, a thioindigo pigment, an isoindolinone pigment, and a quinophthalone pigment; dye lake pigments such as a basic dye lake pigment and an acid dye lake pigment; a nitro pigment; a nitroso pigment; and an aniline black daylight fluorescent pigment.

The content (wt %) of the coloring material in the dispersion liquid is not limited, and can be appropriately determined depending on, for example, a desired optical density or chroma. The content (wt %) of the coloring material is, for example, preferably within a range of 0.1 wt % or more and 20.0 wt % or less, and more preferably within a range of 1.0 wt % or more and 15.0 wt % or less. The coloring material may be used alone or in combination of two or more thereof.

When the first dispersion liquid and the second dispersion liquid are used as the dispersion liquid, the resin layer forming step may include a first step of adhering the first dispersion liquid to the non-permeable substrate by ejecting the first dispersion liquid from an inkjet head, and fixing the resin particles as a first resin layer on the non-permeable substrate, and a second step of adhering the second dispersion liquid to the first resin layer by ejecting the second dispersion liquid from an inkjet head, and laminating the resin particles as a second resin layer on the first resin layer. Accordingly, the image has good color development, and the non-permeable substrate has excellent color concealment properties. Further, the dispersion liquid may be three or more dispersion liquids, and the resin layer may be three or more layers.

The white pigment is preferably, for example, zinc oxide (C.I. Pigment White (hereinafter also referred to as “CIPW”) 4), titanium oxide (CIPW 6), zinc sulfide (CIPW 7), zirconium oxide (zirconium white, CIPW 12), calcium carbonate (CIPW 18), aluminum oxide/silicon oxide (kaolin clay, CIPW 19), barium sulfate (CIPW 21 or 22), aluminum hydroxide (alumina white, CIPW 23), silicon oxide (CIPW 27), and calcium silicate (CIPW 28). Inorganic particles for use in the white pigment may be single particles, or may be composite particles with oxides of silicon, aluminum, zirconium, titanium, or the like, organometallic compounds, and organic compounds. Among them, titanium oxide is suitable for use because of having a lower specific gravity and a higher refractive index than other white pigments, and thus having excellent concealment and coloring properties for the substrate, and excellent durability against acids, alkalis, and other environments. Note that, in addition to titanium oxide, other white pigments (other than the above white pigments) may be used in combination.

The dispersion liquid may further contain a surfactant, water, and a known additive. Examples of the additive include a pH adjuster, a viscosity adjuster, a surface tension adjuster, a preservative, an antifungal agent, a leveling agent, an antifoaming agent, a light stabilizer, an antioxidant, a nozzle drying inhibitor, a polymer component such as an emulsion, and a dye.

The dispersion liquid is allowed to adhere to the non-permeable substrate or the already formed resin layer by being ejected from an inkjet head toward the non-permeable substrate. The inkjet head is one that ejects minute droplets through a nozzle, and a known inkjet head is used. The dispersion liquid may be applied to cover the entire non-permeable substrate or resin layer, or may be applied only to a part of the non-permeable substrate or the resin layer. Then, the dispersion liquid adhering to the non-permeable substrate or the resin layer is heated to melt the resin particles, and a resin layer is formed. When two or more resin layers are formed, for example, ejection of the dispersion liquid from the inkjet head and the heating are repeatedly performed in order for a base layer and a surface layer.

In the resin layer forming step, the amount of dispersion liquid applied to the non-permeable substrate is preferably within a range of 0.1 mg/cm² to 10 mg/cm², more preferably within a range of 0.5 mg/cm² to 10 mg/cm², and particularly preferably within a range of 1.0 mg/cm² to 10 mg/cm². When the amount of the dispersion liquid is within the above range, the image has good color development and little unevenness. In addition, the transfer sheet has excellent peelability. It is thought that when the application amount of the dispersion liquid increases and the thickness of the resin layer increases, the transfer sheet adheres to the resin layer during transfer, resulting in poor peelability. On the other hand, it is thought that when the application amount of the dispersion liquid decreases and the thickness of the resin layer decreases, the resin layer that retains the sublimable dye ink decreases, resulting in poor color development.

In the transfer step, a transfer sheet having a sublimable dye ink layer adheres to the resin layer, and a sublimable dye ink in the sublimable dye ink layer is transferred to the resin layer by heating. After the transfer, the transfer sheet is peeled off from the resin layer.

The transfer sheet having a sublimable dye ink layer is formed by a known method. Examples of a substrate for the transfer sheet include paper and a resin. A sublimable dye ink layer having a desired image is formed by ejecting, from an inkjet head or the like, a sublimable dye ink onto a sheet serving as a substrate. The sublimable dye ink contains a disperse dye that sublimates upon heating, and sublimable dye inks with two or more colors may be used.

The heating temperature when transferring the sublimable dye ink to the resin layer is preferably within a range of 120° C. to 240° C. When the heating temperature is lower than the above range, the transfer efficiency deteriorates. When the heating temperature is higher than the above range, the image may be blurred or the resin layer may deteriorate, influencing the image. The transfer time is not limited, and is within a range of, for example, 30 seconds to 120 seconds.

The sublimable dye ink contains water, a water-soluble organic solvent, and a sublimable dye. The sublimable dye is also called a disperse dye. Examples of the sublimable dye include: C.I. Disperse Red 60; C.I. Disperse Yellow 3, 7, 8, 23, 39, 51, 54, 60, 71, and 86; C.I. Disperse Orange 1, 1:1, 5, 20, 25, 25:1, 33, 56, and 76; C.I. Disperse Brown 2; C.I. Disperse Red 11, 50, 53, 55, 55:1, 59, 60, 65, 70, 75, 93, 146, 158, 190, 190:1, 207, 239, and 240; C.I. Vat Red 41; C.I. Disperse Violet 8, 17, 23, 27, 28, 29, 36, and 57; C.I. Disperse Blue 19, 26, 26:1, 35, 55, 56, 58, 64, 64:1, 72, 72:1, 81, 81:1, 91, 95, 108, 131, 141, 145, and 359; and C.I. Solvent Blue 36, 63, 105, and 111. These may be used alone or in combination of two or more thereof. In addition, the sublimable dye ink may contain components other than those described above (other components). Examples of other components include a dispersant, a preservative and fungicide, a pH adjuster, a chelating reagent, a rust preventive, an ultraviolet absorber, an antifoaming agent, and a surface tension adjuster.

### EXAMPLES

Hereinafter, Examples of the present disclosure will be described.

### Example 1

A dispersion liquid containing 15 wt % of at least one urethane resin (Tg<40° C.) selected from SUPERFLEX 860 and SUPERFLEX 150HS manufactured by DKS Co. Ltd., and HYDRAN AP10, HYDRAN AP-20, and HYDRAN AP-201 manufactured by DIC Corporation and 20 wt % of 1,3-propanediol (manufactured by Tokyo Chemical Industry Co., Ltd.) was sprayed onto a flat plate glass in a rectangular shape of 50 mm×25 mm at an application amount of 1.8 mg/cm² using an inkjet printer (GTX pro manufactured by Brother Industries, Ltd.), followed by heating at 150° C. for 180 seconds to form a resin layer. The volatile component remaining in the resin layer was less than 5%. A transfer sheet, in which a sublimable dye ink was laminated on a paper-made sheet, was placed over the formed resin layer, followed by heating at 160° C. for 120 seconds using a small hand-operated iron press Kabuto PCA-3233, and natural cooling. Then, the transfer sheet was peeled off from the resin layer to form a rectangular filled image on the substrate.

### Example 2

An image was formed in the same manner as in Example 1, except that a vinyl chloride sheet (polyvinyl chloride sheet, Tg=87° C., manufactured by TP Giken Co., Ltd.) was used as the non-permeable substrate.

### Example 3

An image was formed in the same manner as in Example 1, except that the solvent in the dispersion liquid was 40 wt % and the amount of the volatile component remaining in the resin layer was 25 wt %.

### Example 4

An image was formed in the same manner as in Example 1, except that the application amount of the dispersion liquid was 12 mg/cm².

### Example 5

An image was formed in the same manner as in Example 1, except that the application amount of the dispersion liquid was 0.4 mg/cm².

### Example 6

An image was formed in the same manner as in Example 1, except that the transfer sheet was heated at 220° C. for 60 seconds.

### Example 7

An image was formed in the same manner as in Example 1, except that the transfer sheet was heated at 90° C. for 60 seconds.

### Example 8

An image was formed in the same manner as in Example 1, except that a polycarbonate (polycarbonate plate, Tg=150° C., manufactured by TP Giken Co., Ltd.) was used as the non-permeable substrate.

### Example 9

An image was formed in the same manner as in Example 1, except that the dispersion liquid contained, instead of the urethane resin, 15 wt % of at least one polyester resin (Tg<40° C.) selected from PESRESIN A-110F and PESRESIN A-680 manufactured by Matsumoto Yushi-Seiyaku Co., Ltd, and ELITEL KT-0507, ELITEL KT-8701, and ELITEL KT-9204 manufactured by UNITIKA LTD.

### Example 10

An image was formed in the same manner as in Example 1, except that the dispersion liquid contained, instead of the urethane resin, 15 wt % of at least one acrylic resin A (Tg<40° C.) selected from Mowinyl 6820, Mowinyl 7523, and Mowinyl 6763 manufactured by Japan Coating Resin co., ltd., and VONCOAT R-3380-E and VONCOAT H-5 manufactured by DIC Corporation.

### Example 11

An image was formed in the same manner as in Example 1, except that the dispersion liquid contained 5 wt % of a urethane resin and 15 wt % of a polyester resin.

### Example 12

An image was formed in the same manner as in Example 1, except that the dispersion liquid contained 5 wt % of a urethane resin and 15 wt % of an acrylic resin A.

### Example 13

An image was formed in the same manner as in Example 1, except that the dispersion liquid contained, instead of the urethane resin, 15 wt % of at least one acrylic resin B (Tg≥40° C.) selected from Mowinyl 6899D and Mowinyl 6800 manufactured by Japan Coating Resin co., ltd., and VONCOAT AN-1170 and VONCOAT SK-105E manufactured by DIC Corporation.

### Example 14

An image was formed in the same manner as in Example 1, except that the dispersion liquid contained, instead of the urethane resin, 15 wt % of at least one polyester resin (Tg≥40° C.) selected from PESRESIN A-520, PESRESIN A-647GEX, and PESRESIN A-684G manufactured by Matsumoto Yushi-Seiyaku Co., Ltd, and ELITEL KA-5034 and ELITEL KT-8803 manufactured by UNITIKA LTD.

### Example 15

An image was formed in the same manner as in Example 1, except that the dispersion liquid contained 15 wt % of an acrylic resin B instead of the urethane resin, and further contained, as a crosslinking agent, 5 wt % of at least one blocked isocyanate-based crosslinking agent selected from MEIKANATE TP-10 and NBP-211 manufactured by Meisei Chemical Works, Ltd., and ELASTRON E-37 and ELASTRON H-15 manufactured by DKS Co. Ltd.

### Example 16

A dispersion liquid containing 15 wt % of an acrylic resin B, 10 wt % of titanium oxide particles, and 20 wt % of 1,3-propanediol (manufactured by Tokyo Chemical Industry Co., Ltd.) was sprayed onto a flat plate glass in a rectangular shape of 50 mm×25 mm at an application amount of 1.8 mg/cm² using an inkjet printer (GTX pro manufactured by Brother Industries, Ltd.), followed by heating at 150° C. for 180 seconds to form a white resin layer. Further, a dispersion liquid containing 15 wt % of an acrylic resin B and 20 wt % of 1,3-propanediol (manufactured by Tokyo Chemical Industry Co., Ltd.) and containing no white pigment was sprayed over the white resin layer using an inkjet head, followed by heating at 150° C. for 180 seconds to laminate a transparent resin layer on the white resin layer. The volatile component remaining in the resin layer was less than 5%. A transfer sheet, in which a sublimable dye ink was laminated on a paper-made sheet, was placed over the formed resin layer, followed by heating at 160° C. for 120 seconds using a small hand-operated iron press Kabuto PCA-3233, and natural cooling. Then, the transfer sheet was peeled off from the resin layer to form a rectangular filled image on the substrate.

### Example 17

An image was formed in the same manner as in Example 15, except that the dispersion liquid forming the white resin layer contained 5 wt % of a crosslinking agent.

### Comparative Example 1

An ultraviolet curable ink was sprayed onto a glass-made flat plate in a rectangular shape of 20 mm×50 mm using an inkjet printer (GTX pro manufactured by Brother Industries, Ltd.) to form a filled image.

### Comparative Example 2

An image was formed in the same manner as in Comparative Example 1, except that one containing a white pigment was used as the ultraviolet curable ink.

### Comparative Example 3

A dispersion liquid containing a pigment as a coloring material and containing, as a resin component, 15 wt % of at least one urethane resin selected from SUPERFLEX 860 and SUPERFLEX 150HS manufactured by DKS Co. Ltd., and HYDRAN AP10, HYDRAN AP-20, and HYDRAN AP-201 manufactured by DIC Corporation was sprayed onto a flat plate glass in a rectangular shape of 50 mm×25 mm using an inkjet printer (GTX pro manufactured by Brother Industries, Ltd.), followed by heating to form a rectangular filled image.

### Comparative Example 4

An ink same as the above sublimable dye ink was sprayed onto a flat plate glass in a rectangular shape of 50 mm×25 mm using an inkjet printer (GTX pro manufactured by Brother Industries, Ltd.) to form a filled image. The transfer conditions in the printer were 160° C. and 120 seconds.

### Comparative Example 5

A dispersion liquid containing 15 wt % of a urethane resin was sprayed onto a flat plate glass in a rectangular shape of 50 mm×25 mm using an inkjet printer (GTX pro manufactured by Brother Industries, Ltd.), followed by heating to form a resin layer. An ink same as the above sublimable dye ink was sprayed onto the resin layer in 50 mm×25 mm using an inkjet printer (GTX pro manufactured by Brother Industries, Ltd.) to form a filled image. The transfer conditions in the printer were 160° C. and 120 seconds.

### (Color Development Test)

The optical density (OD value) at three locations in the formed image was measured using a spectrophotometer SpectoroEye (light source: D50, viewing angle: 2°, ANSI-T) manufactured by X-Rite, and the average value was obtained and evaluated based on the following evaluation criteria.
5: 2.0 or more
4: 1.5 or more and less than 2.0
3: 1.0 or more and less than 1.5
2: 0.5 or more and less than 1.0
1: less than 0.5 or no color development

### (Peelability Test)

The peelability of the transfer sheet when an image was formed using the transfer sheet was evaluated based on the following criteria.
5: easy peeling off can be made
4: some peeling marks remain on the resin layer
3: many peeling marks remain on the resin layer
2: the transfer sheet remains on the resin layer
1: peeling off cannot be made

### (Image Quality Test)

The image quality of the formed image was visually evaluated according to the following evaluation criteria.
5: no unevenness during printing
4: some unevenness during printing
3: unevenness throughout printing
2: unevenness throughout printing, and dye movement has occurred
1: transfer cannot be made

### (Bleeding Test)

Whether there was any bleeding in the formed image was visually determined based on the following evaluation criteria.
∘: no bleeding
x: bleeding

### (Irregularity Test of Printed Part)

Whether there was any irregularity in the formed image was visually determined based on the following evaluation criteria.
∘: no irregularity
x: irregularity

### (Substrate Color Concealment Test)

Whether the color of the non-permeable substrate on which the image was formed was concealed was visually determined.
∘: the substrate color is concealed
x: the substrate color is not concealed

The results of each test are shown in Tables 1 to 3.

TABLE 1

| | | | Example 1 | Example 2 | Example 3 | Example 4 |
|---|---|---|---|---|---|---|
| Non-permeable substrate | | | Glass | Glass | Glass | Glass |
| Printing method | | | Resin layer | Resin layer | Resin layer | Resin layer |
| | | | formation and | formation and | formation and | formation and |
| | | | then sublimable | then sublimable | then sublimable | then sublimable |
| | | | dye transfer | dye transfer | dye transfer | dye transfer |
| Dispersion | Resin | Urethane resin | ○ | ○ | ○ | ○ |
| liquid | | Urethane resin Tg | <40° C. | <40° C. | <40° C. | <40° C. |
| component | | Polyester resin | — | — | — | — |
| | | Polyester resin Tg | — | — | — | — |
| | | Acrylic resin | — | — | — | — |
| | | Acrylic resin Tg | — | — | — | — |
| | Crosslinking agent | | | — | — | — |
| | White pigment | | | — | — | — |
| Application amount (mg/cm²) | | | 1.8 | 1.8 | 1.8 | 12 |
| Amount (%) of volatile component remaining in resin | | | <5 | <5 | 25 | <5 |
| layer | | | | | | |
| Transfer | Transfer temperature (° C.) | | 160 | 160 | 160 | 160 |
| condition | Time (sec) | | 120 | 120 | 120 | 120 |
| Evaluation | Color development | | 3 | 1 | 3 | 3 |
| | Transfer sheet peelability | | 3 | 1 | 3 | 2 |
| | Image quality | | 5 | 5 | 1 | 3 |
| | Bleeding | | ○ | ○ | ○ | ○ |
| | Irregularity of printed part | | ○ | ○ | ○ | ○ |
| | Substrate color concealment | | — | — | — | — |
| | | | Example 5 | Example 6 | Example 7 | Example 8 |
| Non-permeable substrate | | | Glass | Glass | Glass | Polycarbonate |
| Printing method | | | Resin layer | Resin layer | Resin layer | Resin layer |
| | | | formation and | formation and | formation and | formation and |
| | | | then sublimable | then sublimable | then sublimable | then sublimable |
| | | | dye transfer | dye transfer | dye transfer | dye transfer |
| Dispersion | Resin | Urethane resin | ○ | ○ | ○ | ○ |
| liquid | | Urethane resin Tg | <40° C. | <40° C. | <40° C. | <40° C. |
| component | | Polyester resin | — | — | — | — |
| | | Polyester resin Tg | — | — | — | — |
| | | Acrylic resin | — | — | — | — |
| | | Acrylic resin Tg | — | — | — | — |

| | Crosslinking agent | — | — | — | — |
|---|---|---|---|---|---|
| | White pigment | — | — | — | — |
| Application amount (mg/cm²) | | 0.4 | 1.8 | 1.8 | 1.8 |
| Amount (%) of volatile component remaining in resin | | <5 | <5 | <5 | <5 |
| layer | | | | | |
| Transfer | Transfer temperature (° C.) | 160 | 220 | 90 | 160 |
| condition | Time (sec) | 120 | 60 | 60 | 120 |
| Evaluation | Color development | 2 | 3 | 2 | 3 |
| | Transfer sheet peelability | 3 | 2 | 4 | 3 |
| | Image quality | 5 | 5 | 5 | 5 |
| | Bleeding | ○ | ○ | ○ | ○ |
| | Irregularity of printed part | ○ | ○ | ○ | ○ |
| | Substrate color concealment | — | — | — | — |

TABLE 2

| | | | Example 9 | Example 10 | Example 11 | Example 12 | Example 13 |
|---|---|---|---|---|---|---|---|
| Non-permeable substrate | | | Glass | Glass | Glass | Glass | Glass |
| Printing method | | | Resin layer | Resin layer | dye transfer | Resin layer | Resin layer |
| | | | formation | formation | Resin layer | formation | formation |
| | | | and then | and then | formation | and then | and then |
| | | | sublimable | sublimable | and then | sublimable | sublimable |
| | | | dye transfer | dye transfer | sublimable | dye transfer | dye transfer |
| Dispersion | Resin | Urethane resin | — | — | ○ | ○ | — |
| liquid | | Urethane resin Tg | — | — | <40° C. | <40° C. | — |
| component | | Polyester resin | A | — | A | — | — |
| | | Polyester resin Tg | <40° C. | — | <40° C. | — | — |
| | | Acrylic resin | — | A | — | A | B |
| | | Acrylic resin Tg | — | <40° C. | — | <40° C. | <40° C. |

| | Crosslinking agent | — | — | — | — | — |
|---|---|---|---|---|---|---|
| | White pigment | — | — | — | — | — |
| Application amount (mg/cm²) | | 1.8 | 1.8 | 1.8 | 1.8 | 1.8 |
| Amount (%) of volatile component remaining in | | <5 | <5 | <5 | <5 | <5 |
| resin layer | | | | | | |
| Transfer | Transfer temperature (° C.) | 160 | 160 | 160 | 160 | 160 |
| condition | Time (sec) | 120 | 120 | 120 | 120 | 120 |
| Evaluation | Color development | 4 | 4 | 4 | 4 | 4 |
| | Transfer sheet peelability | 3 | 3 | 3 | 3 | 4 |
| | Image quality | 5 | 5 | 5 | 5 | 5 |
| | Bleeding | ○ | ○ | ○ | ○ | ○ |
| | Irregularity of printed part | ○ | ○ | ○ | ○ | ○ |
| | Substrate color concealment | — | — | — | — | — |

| | | | Example 14 | Example 15 | Example 16 | Example 17 |
|---|---|---|---|---|---|---|
| Non-permeable substrate | | | Glass | Glass | Glass | Glass |
| Printing method | | | Resin layer | Resin layer | Resin layer | Resin layer |
| | | | formation and | formation and | formation and | formation and |
| | | | then sublimable | then | then | then |
| | | | dye transfer | sublimable | sublimable | sublimable dye |
| | | | | dye transfer | dye transfer | transfer |
| Dispersion | Resin | Urethane resin | — | — | — | — |
| liquid | | Urethane resin Tg | — | — | — | — |
| component | | Polyester resin | B | — | — | — |
| | | Polyester resin Tg | <40° C. | — | — | — |
| | | Acrylic resin | — | B | B | ○ |
| | | Acrylic resin Tg | — | <40° C. | <40° C. | <40° C. |

| | Crosslinking agent | — | ○ | — | ○ |
|---|---|---|---|---|---|
| | White pigment | — | — | ○ | ○ |
| Application amount (mg/cm²) | | 1.8 | 1.8 | 1.8 | 1.8 |
| Amount (%) of volatile component remaining in | | <5 | <5 | <5 | <5 |
| resin layer | | | | | |
| Transfer | Transfer temperature (° C.) | 160 | 160 | 160 | 160 |
| condition | Time (sec) | 120 | 120 | 120 | 120 |
| Evaluation | Color development | 4 | 5 | 5 | 5 |
| | Transfer sheet peelability | 4 | 5 | 4 | 5 |
| | Image quality | 5 | 5 | 5 | 5 |
| | Bleeding | ○ | ○ | ○ | ○ |
| | Irregularity of printed part | ○ | ○ | ○ | ○ |
| | Substrate color concealment | — | — | ○ | ○ |

TABLE 3

| | | Comparative | Comparative | Comparative |
|---|---|---|---|---|
| | | Example 1 | Example 2 | Example 3 |
| Non-permeable substrate | | Glass | Glass | Glass |
| Printing method | | UV ink direct | UV ink direct | Direct printing with |
| | | printing | printing | resin-containing ink |
| Application amount (mg/cm²) | | — | — | 1.8 |
| Amount (%) of volatile component | | — | — | <5 |
| remaining in resin layer | | | | |
| Transfer | Transfer temperature (° C.) | 160 | 160 | 160 |
| condition | Time (sec) | 120 | 120 | 120 |
| Evaluation | Color development | 5 | 5 | 4 |
| | Transfer sheet peelability | — | — | — |
| | Image quality | 5 | 5 | 5 |
| | Bleeding | ○ | ○ | × |
| | Irregularity of printed part | × | × | ○ |
| | Substrate color concealment | — | ○ | — |

| | | Comparative | Comparative |
|---|---|---|---|
| | | Example 4 | Example 5 |
| Non-permeable substrate | | Glass | Glass |
| Printing method | | Sublimation ink | Resin layer |
| | | direct printing | formation and then |
| | | | sublimation ink |
| | | | direct printing |
| Application amount (mg/cm²) | | — | 1.8 |
| Amount (%) of volatile component | | — | <5 |
| remaining in resin layer | | | |
| Transfer condition | Transfer temperature (° C.) | 160 | 160 |
| | Time (sec) | 120 | 120 |
| Evaluation | Color development | 1 | 1 |
| | Transfer sheet peelability | — | 3 |
| | Image quality | Unidentifiable | Unidentifiable |
| | Bleeding | × | × |
| | Irregularity of printed part | ○ | ○ |
| | Substrate color concealment | — | — |

### (Color Development Test Evaluation)

It can be seen that Examples 1 to 17 have more excellent color development than Comparative Examples 4 and 5. In particular, Examples 9 to 17, in which the dispersion liquid contains at least one of a polyester resin and an acrylic resin, have an evaluation of 4 or more and have excellent color development.

### (Peelability Test Evaluation)

It can be seen that Examples 1 and 3 to 17, in which the non-permeable substrate is a flat plate glass or a polycarbonate, have more excellent peelability of the transfer sheet than Example 2, in which the non-permeable substrate is vinyl chloride. In addition, Examples 9 to 17, in which the dispersion liquid contains at least one of a polyester resin and an acrylic resin, have an evaluation of 3 or more and have excellent peelability. In particular, Examples 13, 15, and 16, in which the dispersion liquid contains the acrylic resin B having a glass transition point of 40° C. or higher, have an evaluation of 4 or more and have particularly excellent peelability.

### (Image Quality Test Evaluation)

It can be seen that Examples 1 to 2 and 4 to 17, in which the amount of the volatile component remaining in the resin layer is less than 5 wt %, have a more excellent image quality than Example 3, in which the amount of the volatile component remaining in the resin layer is 25 wt %. In addition, it can be seen that Examples 1 to 2 and 5 to 17, in which the application amount of the dispersion liquid is 1.8 mg/cm², have a more excellent image quality than Example 4, in which the application amount of the dispersion liquid is 12 mg/cm². From these results, it is presumed that the fewer volatile component remaining in the resin layer, the better the image quality.

### (Bleeding Test Evaluation)

It can be seen that in Examples 1 to 17, an image without bleeding is formed.

### (Irregularity Test Evaluation of Printed Part)

It can be seen that in Examples 1 to 16, an image without irregularity is formed in the printed part.

### (Substrate Color Concealment Test Evaluation)

It can be seen that Examples 16 and 17, in which the dispersion liquid contains a white pigment, conceal the substrate color as compared to Examples 1 to 15, in which the dispersion liquid does not contain a white pigment.

### (Comprehensive Evaluation)

In Examples 1 to 17, an image having good peelability of the transfer sheet and good color development without bleeding or unevenness is formed on the non-permeable substrate. In addition, since the dispersion liquid is ejected from the inkjet head onto the non-permeable substrate, a resin layer is formed on a part of the non-permeable substrate. In addition, the transfer sheet has excellent peelability. In addition, the formed image has no irregularity.

In particular, in Examples 1 and 3 to 17 in which the non-permeable substrate is a flat plate glass or a polycarbonate, the transfer sheet has better peelability and an image having good color development without bleeding or unevenness is formed, as compared to Example 2 in which the non-permeable substrate is vinyl chloride. It can be seen that Examples 1 to 2 and 4 to 17, in which the amount of the volatile component remaining in the resin layer is less than 5 wt %, have an even more excellent image quality than Example 3, in which the amount of the volatile component remaining in the resin layer is 25 wt %. In addition, it can be seen that Examples 9 to 17, in which the dispersion liquid contains at least one of a polyester resin and an acrylic resin, have more excellent color development and peelability of the transfer sheet than other Examples. In particular, Examples 13, 15, and 16, in which the dispersion liquid contains the acrylic resin B having a glass transition point of 40° C. or higher, have more excellent color development and peelability of the transfer sheet than other Examples.

Obviously, numerous modifications and variations of the present invention(s) are possible in light of the above teachings. It is therefore to be understood that within the scope of the appended claims, the invention(s) may be practiced otherwise than as specifically described herein.

What is claimed is:

1. An image forming method for forming an image on a non-permeable substrate, which is water proof, the image forming method comprising:
forming a resin layer on the non-permeable substrate;
adhering a transfer sheet having a sublimable dye ink layer on a surface thereof to the resin layer, the sublimable dye ink layer comprising a sublimable dye ink; and
heating the transfer sheet to transfer the sublimable dye ink to the resin layer,
wherein forming the resin layer comprises ejecting a dispersion liquid which comprises resin particles from an inkjet head to be adhered to the non-permeable substrate, such that the resin particles are fixed on the non-permeable substrate to form the resin layer.

2. The image forming method according to claim 1, wherein the non-permeable substrate comprises an inorganic material or a resin material having a glass transition point of 90° C. or higher.

3. The image forming method according to claim 1, wherein a content of a volatile component in the resin layer is 20 wt % or less.

4. The image forming method according to claim 3, wherein ejecting comprises ejecting the dispersion liquid onto the non-permeable substrate in an amount of the non-permeable substrate of 0.1 mg/cm² to 10 mg/cm².

5. The image forming method according to claim 4, wherein heating comprises heating the transfer sheet at a temperature in a range of 100° C. to 240° C.

6. The image forming method according to claim 5, wherein the resin particles comprise at least one resin selected from the group consisting of a urethane-based resin, a polyester-based resin, and an acrylic resin.

7. The image forming method according to claim 5, wherein the resin particles comprise at least one resin selected from the group consisting of a polyester-based resin and an acrylic resin.

8. The image forming method according to claim 7, wherein the polyester-based resin or the acrylic resin has a glass transition point of 40° C. or higher.

9. The image forming method according to claim 8, wherein the dispersion liquid further comprises a crosslinking agent.

10. The image forming method according to claim 8, wherein
the dispersion liquid comprises: a first dispersion liquid which comprises resin particles and a coloring material; and a second dispersion liquid which comprises resin particles and no coloring material, and
forming the resin layer further comprises: ejecting the first dispersion liquid from an inkjet head to be adhered to the non-permeable substrate; fixing the resin particles on the non-permeable substrate to form a first resin layer by heating; and ejecting the second dispersion liquid from an inkjet head to be adhered to the first resin layer such that the resin particles are laminated on the first resin layer to form a second resin layer.

11. The image forming method according to claim 2, wherein a content of a volatile component in the resin layer is 20 wt % or less.

12. The image forming method according to claim 11, wherein ejecting comprises ejecting the dispersion liquid onto the non-permeable substrate in an amount of the non-permeable substrate of 0.1 mg/cm² to 10 mg/cm².

13. The image forming method according to claim 12, wherein heating comprises heating the transfer sheet at a temperature in a range of 100° C. to 240° C.

14. The image forming method according to claim 13, wherein the resin particles comprise at least one resin selected from the group consisting of a urethane-based resin, a polyester-based resin, and an acrylic resin.

15. The image forming method according to claim 13, wherein the resin particles comprise at least one resin selected from the group consisting of a polyester-based resin and an acrylic resin.

16. The image forming method according to claim 15, wherein the polyester-based resin or the acrylic resin has a glass transition point of 40° C. or higher.

17. The image forming method according to claim 16, wherein the dispersion liquid further comprises a crosslinking agent.

18. The image forming method according to claim 16 wherein
the dispersion liquid comprises: a first dispersion liquid which comprises resin particles and a coloring material; and a second dispersion liquid which comprises resin particles and no coloring material, and
forming the resin layer further comprises: ejecting the first dispersion liquid from an inkjet head to be adhered to the non-permeable substrate; fixing the resin particles on the non-permeable substrate to form a first resin layer by heating; and ejecting the second dispersion liquid from an inkjet head to be adhered to the first resin layer such that the resin particles are laminated on the first resin layer to form a second resin layer.
